(19) United States
(12) Patent Application Publication
(10) Pub. No.: US 2008/0028899 A1
(43) Pub. Date: Feb. 7, 2008

(54) Hand tool

(76) Inventors: Christopher P. Scott, Hackensack, NJ (US); Richard A. Modes, Hopatcong, NJ (US)

Correspondence Address: THE LAW OFFICE OF JOHN A. GRIECCI, 703 PIER AVE., SUITE B #657, HERMOSA BEACH, CA, 90254, US

(21) Appl. No.: 11/888,714

(22) Filed: Aug. 1, 2007

Related U.S. Application Data
(60) Provisional application No. 60/835,299, filed on Aug. 3, 2006.

(51) Int. Cl. B25B 23/142

(52) U.S. Cl. 81/177.7; 81/436; 81/489

(57) ABSTRACT

A hand tool having a handle assembly with a bearing mechanism providing for continual axial loading to be applied while a torque is applied via an attached lever arm. The lever arm is mounted to the handle assembly proximate a junction of the handle assembly and a drive shaft, and is constructed to fold into the handle assembly when not in use. Alternatively, the screwdriver handle grip can freely rotate about the drive shaft as an axial load is applied, and a folding crank is used to drive the shaft. The screwdriver functions traditionally when its lever arm is folded into the handle assembly.

This application claims the benefit of U.S. provisional Application No. 60/835,299, filed Aug. 3, 2006, which is incorporated herein by reference for all purposes.

The present invention relates generally to a hand tool, and more particularly, to a screwdriver-type handle including an axial thrust bearing and a torque lever.

### BACKGROUND OF THE INVENTION

A standard screwdriver includes a handle rigidly affixed to and axially (i.e., longitudinally) aligned with a shaft forming a head. The head may be of a number of types, including a standard blade, a Phillips head, and a hex-driver head. In use, an axial force is applied to the screwdriver while also applying torque. In order to minimize slippage from the screw head, it may be necessary to maintain a significant level of axial force. Users therefore may find it difficult to adequately maintain this force alignment while twisting the wrist of the hand that grips the screwdriver handle. The problem can be exacerbated when the fastener is well fixed, and the operator is required to apply significant torque to loosen (or further tighten) the fastener.

Existing products in the marketplace attempt to provide greater mechanical advantage while generating torque by increasing the diameter of the screwdriver handle, and ratcheting mechanisms have been added to facilitate ease of use while rotating a fastener through multiple revolutions (e.g., see U.S. Pat. Nos. 4,621,718 and 4,777,852). Additionally, it is known to provide a screwdriver with a wrench engaging collar incorporated into the shaft, thus allowing the use of an open end wrench to increase mechanical advantage (e.g., see U.S. Pat. No. 5,642,649).

While these products facilitate certain tasks, none provides a user with the ability to continually maintain a force aligned with the axis of the screwdriver shaft without having to rotate the wrist applying the axial force. Additionally, the prior devices only provide significant mechanical advantage through the use of additional tools.

Among other features known for screwdrivers, a screwdriver handle can optionally have a longitudinally extending pocket-clip that is used to hold the screwdriver in a shirt pocket in a fashion similar to a pen.

Accordingly, there has existed a need for a simple, ergonomic screwdriver device allowing for axial force to be applied independent of a twisting motion, and providing mechanical advantage in torquing down a fastener. Preferred embodiments of the present invention satisfy these and other needs, and provide further related advantages.

### SUMMARY OF THE INVENTION

In various embodiments, the present invention may solve some or all of the needs mentioned above. Typical embodiments of the invention provide a hand tool that allows a user to apply axial (i.e., longitudinal) force to a fastener with a non-rotating hand, while applying torsion with a second hand.

A typical hand tool for a user to rotate a fastener around a longitudinal axis under the invention includes a drive body, a lever arm, a thrust body, and a tip. The tip is configured for mating with the fastener, and has appropriate drive surfaces adapted to drive the fastener in rotation around the longitudinal axis. The drive body is connected to the tip so as to drive the tip in rotation around the longitudinal axis as the drive body rotates around the longitudinal axis. Advantageously, the lever arm is affixed to the drive body and laterally extends from the drive body to provide leverage in turning the drive body around the longitudinal axis.

The thrust body is connected to the tip and drive body via a thrust bearing such that the thrust body is configured to rotate around the longitudinal axis freely with respect to the tip and drive body. The thrust body is sized and positioned for a user to manually apply axial thrust to the tip while the tip and drive body are rotating around the longitudinal axis. This feature advantageously allows the thrust body to be used for applying a force (thrust) to maintain the mated relationship of the tip and the fastener, without the hand applying the force having to rotate.

The lever arm is hingedly attached to the drive body such that it can be rotated between an extended position in which it laterally extends from the drive body in a direction normal to the longitudinal axis, and a stowed position in which it extends longitudinally. This provides for the tool to be carried and stored similar to a traditional screwdriver.

In the extended position, the lever arm extends from the drive body in a direction normal to the longitudinal axis, providing for leverage. In its stowed position, the lever arm locks the thrust body from rotation with respect to the drive body, thereby allowing the hand tool to operate just as does a typical screwdriver.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is a perspective view of a first hand tool embodying the present invention, and a fastener.

FIG. 2 is a front cross-sectional view of the hand tool of FIG. 1.

FIG. 3 is a perspective view of a second hand tool embodying the present invention, and a fastener.

FIG. 4 is a front cross-sectional view of the hand tool of FIG. 3.

### DETAILED DESCRIPTION OF THE PREFERRED EMBODIMENTS

The invention summarized above and defined by the enumerated claims may be better understood by referring to the following detailed description, which should be read with the accompanying drawings. This detailed description of particular preferred embodiments of the invention, set out below to enable one to build and use particular implementations of the invention, is not intended to limit the enumerated claims, but rather, it is intended to provide particular examples of them.

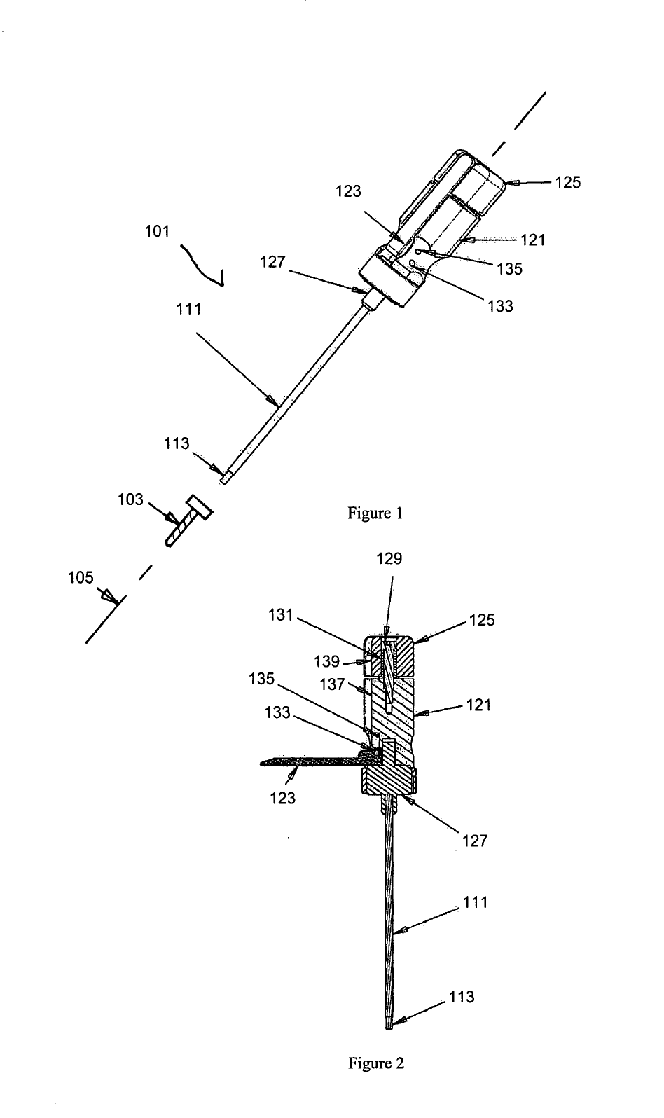

With reference to FIGS. 1 & 2, a first embodiment of the invention is in the form of an ergonomic hand tool 101 for a user to rotate a body such as a fastener 103 around a longitudinal axis 105 with greater torque than might be had using a traditional screwdriver. The hand tool extends longitudinally, and serially includes a handle, a shaft 111 and a drive tip 113. The tip and fastener are in a standard configuration, such as slotted, Phillips, crosspoint or hex. As such, the tip is configured for longitudinally mating with the fastener, and the tip and fastener have drive surfaces (e.g., side surfaces of a slotted tip and screw, or side surfaces of a hex tip and screw) adapted for the tip to drive the fastener in rotation around the longitudinal axis.

The tip 113 is located at a longitudinally distal end of the shaft 111. The tip may be integral with the shaft, or it may mate with the distal end of the shaft to allow for multiple drive tips to be utilized. A proximal end of the shaft connects to the handle. Optionally, the shaft may be detachably mated with the handle to allow for multiple shaft types to be utilized.

The handle assembly includes a drive body 121, a lever arm 123, a thrust body 125, and a ratchet mechanism 127. The thrust body forms a proximal end of the handle assembly. A distal end of the thrust body longitudinally connects to a proximal end of the drive body via a retaining screw 129 and a thrust bearing 131. A distal end of the drive body is rigidly affixed to the ratchet mechanism. The ratchet mechanism forms a distal end of the handle assembly, and receives the proximal end of the shaft 111.

The drive body 121 is configured to drive the tip 113 in rotation around the longitudinal axis 105 as the drive body rotates around the longitudinal axis. More particularly, when a user applies torque around the longitudinal axis of the drive body, the drive body applies the torque to the ratchet mechanism 127, which in turn applies the torque to the shaft 111, which in turn applies the torque to the tip 113, driving it in rotation around the longitudinal axis.

The ratchet mechanism 127 connects the drive body 121 to the tip 113 (via the shaft 111). The ratchet mechanism is of a typical configuration, having a proximal portion connected to the drive body and a distal portion connected to the tip via the shaft. The ratchet mechanism allows the shaft and tip to rotate around the longitudinal axis 105 in one direction with respect to the drive body, while not allowing them to rotate in the other direction with respect to the drive body. Thus, the ratchet mechanism connects the drive body to the tip such that the tip can be driven through unidirectional rotation while the drive body is repeatedly cycled through a limited range of rotation. The ratchet mechanism has a typical internal ratchet configuration, and thus is lockable and reversible. A user can thereby control the direction in which the drive body is locked with respect to the tip, and can lock the mechanism to operate in non-ratchet form.

In this embodiment, the tip 113 and the thrust body 125 are at opposite longitudinal ends of the hand tool 101. The thrust body connects to the tip and drive body 121 via the thrust bearing 131. Thus the thrust body is longitudinally restricted, but is configured to rotate around the longitudinal axis 105 freely with respect to the tip and drive body. As such, a user may apply torque to the drive body as it turns to drive the fastener in rotation, while applying longitudinal thrust to the static (i.e., non-rotating) thrust body. The applied thrust presses the tip against the fastener to maintain their mated relationship. Thus, the thrust body is adapted for a user to manually apply axial thrust to the tip while the tip and drive body are rotating around the longitudinal axis, but without the thrust body (or the user's respective wrist) rotating. While one form of thrust bearing is shown, other forms of low-friction rotational bearing mechanisms are envisaged within the scope of the invention.

A hinged end of the lever arm 123 is hingedly attached to the drive body by a pivot pin 133 such that the lever arm can be rotated between an extended position (as depicted in FIG. 2) in which it laterally extends from the drive body 121 in a direction normal to the longitudinal axis 105, and a stowed position (as depicted in FIG. 1) in which it extends longitudinally along the drive body and the thrust body 125 (i.e., in a direction parallel to the longitudinal axis). In this context, the term laterally extends should be understood to mean extending with a lateral component substantially large enough to provide significant leverage (e.g., by an amount greater than the width of a typical user's finger).

Optionally, other hinge configurations could be used. For example, rather than having the hinge at the end of the lever arm and the end of the drive body opposite the thrust body, the hinge could be in the center of the lever arm. The lever arm would then extend to both sides of the drive body, and either would retract to a slot extending across within the drive and thrust bodies, or would retract tangentially along the outer surface of the drive body. Such alternate embodiments are within the scope of the invention.

Additionally, optionally the hinge could directly attach the lever arm to the proximal portion of the ratchet mechanism, and thus the lever arm is attached to the drive body indirectly via the ratchet mechanism. In an extreme variation of this case, the proximal portion of the ratchet mechanism forms the drive body. This varies from the present embodiment, in which the ratchet mechanism 127 and drive body 121 are separate bodies attached to one another.

A spring-loaded ball plunger lock mechanism 135 is configured to provisionally restrict the lever arm 123 from rotation with respect to the drive body 121 when the lever arm is in the stowed position, and optionally it (or a second lock mechanism) could be configured to lock it in the extended position. Other lock mechanism types such as spring levers are within the scope of the invention.

In its extended position, the lever arm 123 is affixed to the drive body 121 in an orientation that extends from the drive body in a direction normal to the longitudinal axis. In this orientation, the lever arm provides a user with leverage to apply a greater level of torque to the drive body than could easily be accomplished through the direct application of torque to the drive body by the user's hand (i.e., by twisting the user's wrist while manually holding the drive body). The lever arm is configured with adequate strength to drive the drive body in rotation without plastic deformation.

Preferably, the orientation of the lever arm 123 in its extended position is such that it extends substantially at a 90° angle to the longitudinal axis. Such an orientation will minimize the development of undesired non-longitudinal torque, and minimize the necessary length of the lever arm. Nevertheless, there may be other embodiments where the extended position laterally extends from the drive body at an angle other than 90°.

The lever arm 123 hingedly attaches to the drive body 121 at the distal end of the drive body, which is the end that is longitudinally distant from the thrust body. The drive body forms a first recess 137, and the thrust body 125 forms a second recess 139. The drive and thrust bodies are configured such that they can be rotationally oriented with the first and second recesses aligned. With the drive and thrust bodies in such an orientation, the lever arm, in its stowed position, is extends through the first and second recesses. The first and second recesses are sized and shaped to conformingly receive the lever arm in the stowed position, and thus the lever arm is configured to lock the thrust body from rotation with respect to the drive body when the lever arm is in its stowed position. As described above, the lever arm locks in the stowed position, thereby maintaining the lock on the thrust body orientation.

To use the hand tool 101 to screw in a fastener 103, a user might start with the lever arm 123 in the stowed position. The ratchet mechanism 127 is either locked, or adjusted to freely rotate only when the handle assembly is rotated in a fastener-removal direction (e.g., counter-clockwise). In this configuration, the fastener can be held with one hand, and the hand tool can be used to partially screw the fastener in a manner identical to that which would be used with a conventional screwdriver or a standard ratcheting screwdriver (i.e., the tip is mated with the fastener, and then the handle is rotated in a fastener-insertion direction to drive the fastener in rotation while applying a mild longitudinal force with the hand turning the hand tool).

This procedure would be followed until the fastener 103 began to exhibit significant resistance to rotation. At that time, the hand tool could be disconnected from the fastener, and the lever arm 123 would be rotated by the user from its stowed position to its extended position. This configuration change both positions the lever arm for use in torquing down the screw, and rotationally frees up the thrust body, allowing it to rotate freely with respect to the drive body. The tip is again mated with the fastener (unless the hand tool was not previously disconnected from the fastener).

The user then holds the thrust body with a first hand (optionally with the proximal end abutted with the user's palm), and applies a longitudinal force to keep the tip mated with the fastener. With a second hand, the user grasps the lever arm and uses it to apply a torque to the drive body. The lever arm and drive body provide a means for the user to apply significant torque to the fastener. The user's first hand and the thrust body do not rotate with the drive body, thus allowing the user to apply significant longitudinal force without simultaneously having to turn the first hand. While the user's first hand will block the user's second hand from continuously rotating through multiple revolutions, the ratchet facilitates ease of use while rotating the fastener through multiple revolutions. Optionally, a user can skip the first part of the procedure and begin with the lever arm in the extended position.

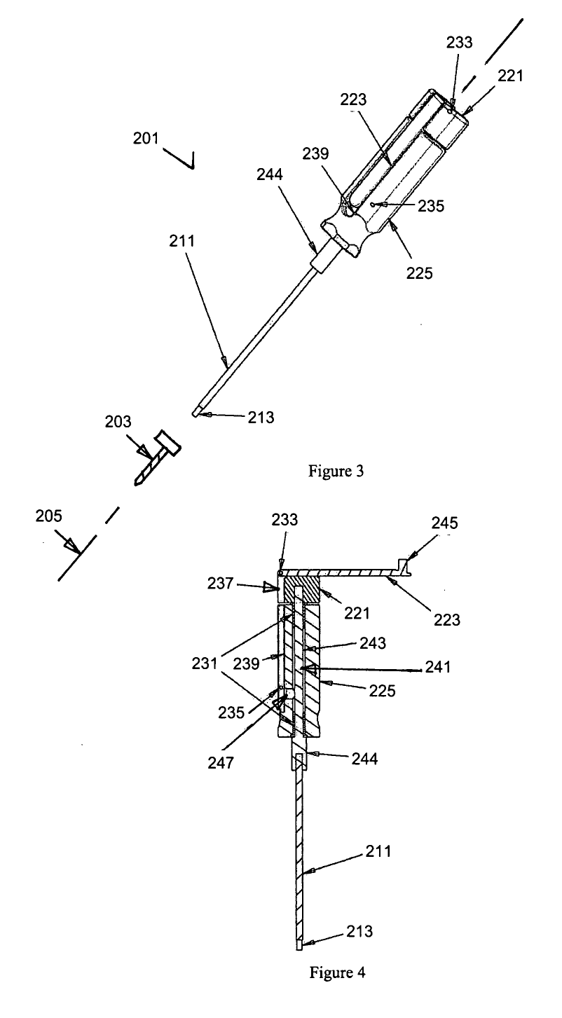

With reference to FIGS. 3 & 4, a second embodiment of the invention is also in the form of an ergonomic hand tool 201 for a user to rotate a body of a fastener 203 around a longitudinal axis 205 with greater torque than might be had using a traditional screwdriver. Although the second embodiment differs in configuration from the first, it has many components that share functionality, and are indicated by similar names and reference numbers that differ only in the hundreds digit.

The hand tool 201 extends longitudinally, and serially includes a handle, a shaft 211 and a drive tip 213. The tip and fastener are in a standard configuration, such as slotted, Phillips, crosspoint or hex. As such, the tip is configured for longitudinally mating with the fastener, and the tip and fastener have drive surfaces adapted for the tip to drive the fastener in rotation around the longitudinal axis.

The tip 213 is located at a longitudinally distal end of the shaft 211. The tip may be integral with the shaft, or it may mate with the distal end of the shaft to allow for multiple drive tips to be utilized. A proximal end of the shaft connects to the handle. Optionally, the shaft may be detachably mated with the handle to allow for multiple shaft types to be utilized.

The handle assembly includes a drive body 221, a lever arm 223, a thrust body 225, and a drive shaft 241, which is an extension of the shaft 211 through the handle assembly. Unlike the previous embodiment, the drive body forms a proximal end of the handle assembly. A distal end of the drive body longitudinally connects to a proximal end of the drive shaft. The drive shaft extends through a longitudinal through-hole 243 in the thrust body, and the thrust body is connected to the drive shaft via a pair of thrust bearings that are longitudinally spaced along the drive shaft 231. The thrust bearings maintain the thrust body between the drive body and a collar 244 on the distal end of the drive shaft, the collar having a larger diameter than the through-hole 243. The drive shaft forms a distal end of the handle assembly, and receives the proximal end of the shaft 211.

The drive body 221 is configured to drive the tip 213 in rotation around the longitudinal axis 205 as the drive body rotates around the longitudinal axis. More particularly, when a user applies torque around the longitudinal axis of the drive body, the drive body applies the torque to the drive shaft 241, which in turn applies the torque to the shaft 211, which in turn applies the torque to the tip 213, driving it in rotation around the longitudinal axis.

In an alternative embodiment, a ratchet mechanism could be incorporated to connect the drive body 221 to the tip 213, similar to that of the first embodiment. Among the possible locations for the ratchet mechanism are locations at either end of the drive shaft.

In this embodiment, the tip 213 and the drive body 221 are at opposite longitudinal ends of the hand tool 201. The thrust body connects to the drive body 221, the drive shaft 241 and the tip via the thrust bearing 231. Thus the thrust body is longitudinally restricted, but is configured to rotate around the longitudinal axis 205 freely with respect to the tip and drive body. As such, a user may apply torque to the drive body as it turns to drive the fastener in rotation, while applying longitudinal thrust to the static (i.e., non-rotating) thrust body. The applied thrust presses the tip against the fastener to maintain their mated relationship. Thus, the thrust body is adapted for a user to manually apply axial thrust to the tip while the tip and drive body are rotating around the longitudinal axis, but without the thrust body (or the user's respective wrist) rotating. As was previously noted, other forms of low-friction rotational bearing mechanisms are envisaged within the scope of the invention.

A hinged end of the lever arm 223 is hingedly attached to the drive body by a pivot pin 233 such that the lever arm can be rotated between an extended position (as depicted in FIG. 4) in which it laterally extends from the drive body 221 in a direction normal to the longitudinal axis 205, and a stowed position (as depicted in FIG. 3) in which it extends longitudinally along the drive body and the thrust body 225 (i.e., in a direction parallel to the longitudinal axis). Optionally, other hinge configurations could be used.

A spring-loaded ball plunger lock mechanism 235 is configured to provisionally lock the lever arm 223 from rotation with respect to the drive body 221 when the lever arm is in the stowed position, and optionally it (or a second lock mechanism) could be configured to lock it in the extended position. Other lock mechanism types such as spring levers are within the scope of the invention.

In its extended position, the lever arm 223 is affixed to the drive body 221 in an orientation that extends from the drive body in a direction normal to the longitudinal axis. In this orientation, the lever arm provides a user with leverage to apply a greater level of torque to the drive body than could easily be accomplished through the direct application of torque to the drive body by the user's hand (i.e., by twisting the user's wrist while manually holding the drive body). The lever arm is configured with adequate strength to drive the drive body in rotation without plastic deformation.

Preferably, the orientation of the lever arm 223 in its extended position is such that it extends substantially at a 90° angle to the longitudinal axis. Such an orientation will minimize the development of undesired non-longitudinal torque, and minimize the necessary length of the lever arm. Nevertheless, as previously noted there may be other embodiments where the extended position laterally extends from the drive body at an angle other than 90°.

Unlike the first embodiment, the lever arm 223 hingedly attaches to the drive body 221 at the proximal end of the drive body. Nevertheless, like the first embodiment, the lever arm attaches to the drive body at an end of the drive body that is distant from the thrust body. The drive body forms a first recess 237, and the thrust body 225 forms a second recess 239. The drive and thrust bodies are configured such that, they can be rotationally oriented with the first and second recesses aligned. With the drive and thrust bodies in such an orientation, the lever arm, in its stowed position, is extends through the first and second recesses. The first and second recesses are sized and shaped to conformingly receive the lever arm in the stowed position, and thus the lever arm is configured to lock the thrust body from rotation with respect to the drive body when the lever arm is in its stowed position. As noted above, the lever arm locks in the stowed position, thereby maintaining the lock on the thrust body orientation.

A free end of the lever arm 223, being opposite the hinged end of the lever arm, is configured with a protrusion in the form of a knob such as a crank pin 245. With the lever arm in its extended position, the crank pin can be grasped and used to rapidly drive the drive body in rotation, and thereby rapidly install or remove a fastener without the multiple ratchet motions or re-grips that would be necessary with a ratchet driver or a standard screwdriver, respectively. With the lever arm in its stowed position, the crank pin is received in a laterally extending bore 247 of the thrust body, further locking the thrust body from rotation around the longitudinal axis with respect to the drive body. Other forms of graspable protrusions that allow a hand to maintain control over the lever arm while rotating it repeatedly, such as circular hole sized to receive a finger, are also within the scope of the invention.

The use of the second embodiment is similar to that of the first embodiment. The primary differences are in the hand positions, and in the availability of the crank. With the second embodiment, the user can easily wrap a first hand around the thrust body to hold the tool with stability while applying thrust, but the user must apply the force along the side of the thrust body rather than to its proximal end. Nevertheless, by positioning the drive body at the proximal end, the lever arm can be rotated without interference from the user's other hand, while a user's grasp on the lever arm can be maintained by the graspable protrusion (e.g., the crank pin). Thus, the crank pin can be grasped and continuously driven, facilitating ease of use while rotating the fastener through multiple revolutions.

It is to be understood that the invention comprises both hand tool apparatus and related methods for rotating a fastener. Additionally, the various embodiments of the invention can incorporate various combinations of the above-described features. While particular forms of the invention have been illustrated and described, it will be apparent that various modifications can be made without departing from the spirit and scope of the invention.

For example, while the lever arm was disclosed to operate as a thrust-body lock while in the stowed position, a separate thrust-body lock could also be used within the scope of the invention. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claims.

What is claimed is:

1. A hand tool for a user to rotate a fastener around a longitudinal axis, comprising:
a tip configured for mating with the fastener, and configured with a drive surface adapted to drive the fastener in rotation around the longitudinal axis;
a drive body configured to drive the tip in rotation around the longitudinal axis as the drive body rotates around the longitudinal axis;
a lever arm affixed to the drive body and configured to laterally extend from the drive body; and
a thrust body connected to the tip and drive body via a thrust bearing such that the thrust body is configured to rotate around the longitudinal axis freely with respect to the tip and drive body;
wherein the thrust body is adapted for a user to manually apply axial thrust to the tip while the tip and drive body are rotating around the longitudinal axis.

2. The hand tool of claim 1, wherein the lever arm is hingedly attached to the drive body such that it can be rotated between an extended position in which it laterally extends from the drive body in a direction normal to the longitudinal axis, and a stowed position in which it extends longitudinally.

3. The hand tool of claim 2, wherein in the extended position, the lever arm extends from the drive body in a direction normal to the longitudinal axis.

4. The hand tool of claim 2, wherein the lever arm, in its stowed position, locks the thrust body from rotation with respect to the drive body.

5. The hand tool of claim 4, and further comprising a lock configured to restrict the lever arm from rotating out of its stowed position.

6. The hand tool of claim 4, wherein the drive body forms a first recess, wherein the thrust body forms a second recess, and wherein the lever arm, in its stowed position, is configured to extend through the first and second recesses to lock the thrust body from rotation with respect to the drive body.

7. The hand tool of claim 4, wherein the lever arm includes a protrusion, wherein the thrust body forms a laterally extending bore, and wherein the lever arm, in its stowed position, is configured such that its protrusion is received in the laterally extending bore to lock the thrust body from rotation with respect to the drive body.

8. The hand tool of claim 2, and further comprising a lock mechanism configured to lock the lever arm from rotation with respect to the drive body.

9. The hand tool of claim 1, and further comprising a ratchet mechanism connecting the drive body to the tip such that the tip can be driven through unidirectional rotation while the drive body is repeatedly cycled through a limited range of rotation.

10. The hand tool of claim 9, wherein the ratchet mechanism and drive body are separate bodies attached to one another.

11. The hand tool of claim 1, wherein the tip and the thrust body are at opposite longitudinal ends of the hand tool.

12. The hand tool of claim 1, wherein the tip and the drive body are at opposite longitudinal ends of the hand tool, and wherein the lever arm includes a graspable protrusion.
